(19) United States
(12) Patent Application Publication
(10) Pub. No.: US 2026/0226672 A1
(43) Pub. Date: Aug. 6, 2026

(54) FILTER CLEANING DEVICE, CLOTHING TREATMENT APPARATUS, AND METHOD FOR CONTROLLING SAME

(71) Applicant: Nanjing Roborock lnnovation Technology Co., Ltd., Jiangsu (CN)

(72) Inventors: Xianshan HAN, Shenzhen, Guangdong (CN); Tong LIU, Shenzhen, Guangdong (CN); Hang QI, Shenzhen, Guangdong (CN); Wei WANG, Shenzhen, Guangdong (CN); Changjian ZHAO, Shenzhen, Guangdong (CN); Gang QUAN, Shenzhen, Guangdong (CN)

(21) Appl. No.: 19/148,902

(22) PCT Filed: Jan. 16, 2024
(86) PCT No.: PCT/CN2024/072580

§ 371 Date: Jul. 17, 2025

(30) Foreign Application Priority Data
Jan. 17, 2023 (CN) 202310094898.2

(51) Int. Cl. D06F 58/45; B08B 3/02; D06F 58/22

(52) U.S. Cl. CPC D06F 58/45; B08B 3/024; D06F 58/22

(57) ABSTRACT

The present application relates to a filter cleaning device for cleaning a filter in a clothing treatment apparatus. The filter cleaning device includes: a driving mechanism and a spraying mechanism. where the driving mechanism is configured to provide a driving force for the movement of the spraying mechanism; and the spraying mechanism is configured to spray a cleaning fluid onto a preset region of the filter. The present application further relates to a clothing treatment apparatus and a method for controlling the clothing apparatus.

### CROSS-REFERENCE TO RELATED APPLICATIONS

The present application is a National phase of International Patent Application No. PCT/CN2024/072580 with an international filing date of Jan. 16, 2024, designating the United States, now pending, and further claims priority to Chinese patent application with the application number 202310094898.2 and the filing date of Jan. 17, 2023, and claims priority of this Chinese patent application. The entire contents each of which are hereby incorporated by reference into the present disclosure.

### TECHNICAL FIELD

The present application relates to the technical field of household appliances, and in particular, to a filter cleaning device, a clothing treatment apparatus, and a method for controlling the same.

### BACKGROUND

With the continuous advancement of manufacturing technologies and the increasing demands of people's daily life, clothing treatment apparatuses have become ubiquitous in households, emerging as one of the most commonly used household appliances. A clothing treatment apparatus is used to carry out various processes for handling clothing, such as washing, rinsing, ironing, drying, and so forth.

Under normal circumstances, a clothing treatment apparatus includes a filter, which serves to remove clothing debris, paper scraps, cotton fiber, lint, or other impurities generated within the clothing treatment apparatus. When the filter becomes clogged, users are required to remove and clean the filter before resuming the clothing treatment process. This process consumes the user's time and effort and is not sufficiently intelligent.

### SUMMARY

Embodiments of the present application provide a filter cleaning device, a clothing treatment apparatus, and a method for controlling the same. The filter cleaning device is used to spray a filter, thereby removing clothing debris, paper scraps, cotton fibers, lint, or other impurities generated in the clothing treatment apparatus.

The embodiments of the present application provide a filter cleaning device for cleaning a filter in a clothing treatment apparatus. The filter cleaning device includes: a driving mechanism and a spraying mechanism, where
the driving mechanism is configured to provide the driving force for the movement of the spraying mechanism; and
the spraying mechanism is configured to spray a cleaning fluid onto a preset region of the filter.

In one embodiment, the driving mechanism is configured to drive the spraying mechanism to move in a plurality of directions.

In one embodiment, the driving mechanism is configured to drive the spraying mechanism to move in a first direction or a second direction, where the first direction and the second direction are perpendicular to each other.

In one embodiment, the driving mechanism is configured to drive the spraying mechanism to rotate around a rotation axis.

In one embodiment, the area of the preset region is greater than or equal to 80% of the filtration area of the filter.

In one embodiment, the spraying mechanism includes a water supply pipe and a spray head, the spray head being provided with a plurality of spray holes that are spaced apart from each other.

In one embodiment, the water supply pipe and the spray holes are arranged on two surfaces of the spray head that face away from each other.

In one embodiment, the spraying mechanism is configured such that the movement distance in the arrangement direction of the plurality of spray holes is greater than or equal to the minimum distance between two adjacent spray holes.

In one embodiment, the rotation angle of the spraying mechanism ranges from 5° to 45°.

In one embodiment, the spraying mechanism further includes a switch for opening or closing one or more of the plurality of spray holes.

In one embodiment, the filter includes a filtering surface and a non-filtering surface, and the spraying mechanism is arranged on the side of the non-filtering surface.

In one embodiment, the distance between the spraying mechanism and the filter is within the range of 0.4 cm to 1 cm.

The present application further provides a clothing treatment apparatus. The clothing treatment apparatus includes a clothing accommodating device, a drying device, a water supply assembly, and an air outlet duct connecting the clothing accommodating device and the drying device, where the air outlet duct is configured to guide an airflow from the clothing accommodating device to the drying device;
a filter is arranged in the air outlet duct to filter the airflow;
the clothing treatment apparatus further includes the filter cleaning device according to any one of the above embodiments; and
the water supply assembly includes a filter water supply port; the filter water supply port is connected to the spraying mechanism.

In one embodiment, the air outlet duct includes a first end close to the clothing accommodating device and a second end close to the drying device, and the filter cleaning device is arranged in the air outlet duct in a manner spanning across the first end and the second end.

The embodiments of the present application further provide a method for controlling a clothing treatment apparatus. The clothing treatment apparatus includes a clothing accommodating device, a drying device, a water supply assembly, and an air outlet duct connecting the clothing accommodating device and the drying device, where the air outlet duct is configured to guide an airflow from the clothing accommodating device to the drying device;
a filter is arranged in the air outlet duct to filter the airflow;
the clothing treatment apparatus further includes the filter cleaning device according to any one of the above embodiments, configured to spray liquid onto the filter;
the water supply assembly includes at least a filter water supply port; the filter water supply port is connected to the spraying mechanism; and
the filter cleaning device further includes a control module;
the method for controlling the clothing treatment apparatus includes at least:
controlling, by the control module, the supply of water from the filter water supply port to the spraying mechanism;
controlling, by the control module, the driving mechanism to move the spraying mechanism reciprocally along a first direction; and
controlling, by the control module, the driving mechanism to rotate the spraying mechanism reciprocally around a rotation axis of the spraying mechanism, to spray a cleaning fluid onto the filter.

### BRIEF DESCRIPTION OF THE DRAWINGS

To more clearly illustrate the technical solutions in the embodiments of the present application, the drawings required for use in the embodiments will be briefly described below. It should be understood that the following drawings only illustrate some embodiments of the present application and therefore should not be considered as limiting the scope of the present application, and other related drawings can be derived from these drawings by those of ordinary skill in the art without creative efforts.

FIG. 1 is a schematic diagram of a partial structure of a clothing treatment apparatus according to an embodiment of the present application;

FIG. 2 is a schematic diagram of the mounting position of a filter according to an embodiment of the present application;

FIG. 3 is a schematic diagram of a structure of a filter cleaning device according to an embodiment of the present application;

FIG. 4 is a schematic diagram of the mounting position of a filter cleaning device outside a clothing accommodating device according to an embodiment of the present application;

FIG. 5 is a schematic diagram of a partial structure of a filter cleaning device according to an embodiment of the present application;

FIG. 6 is a schematic diagram of a partial structure of a filter cleaning device according to an embodiment of the present application; and

FIG. 7 is a schematic diagram of a structure of an air outlet duct of a clothing treatment apparatus according to an embodiment of the present application.

### DETAILED DESCRIPTION

The technical solutions in the embodiments of the present application will be clearly and completely described hereinafter with reference to the drawings in the embodiments of the present application. It is apparent that the described embodiments are only some, but not all, embodiments of the present application. The assemblies of the embodiments of the present application, generally described and illustrated in the drawing herein, may be arranged and designed in various configurations. Therefore, the following detailed description of the embodiments of the present application provided in the drawings is not intended to limit the scope of the present application as claimed, but merely represents selected embodiments of the present application. Based on the embodiments of the present application, all other embodiments obtained by those skilled in the art without making creative efforts (including new embodiments formed by combining features included in different embodiments) fall within the protection scope of the present application.

It should be noted that similar reference numerals and letters refer to similar items in the following drawings, and thus, once an item is defined in one figure, it need not be further defined or explained in the subsequent drawings. Meanwhile, in the description of the present application, the terms “first”, “second”, etc., are used solely to distinguish descriptions and should not be understood as indicating or implying relative importance.

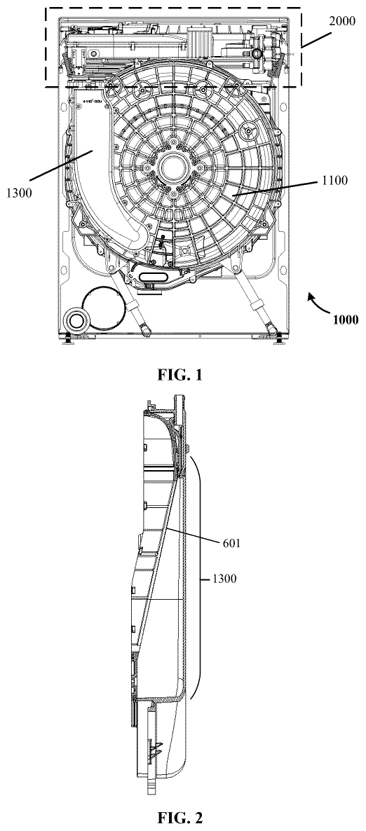

The present application provides a filter cleaning device for cleaning a filter in a clothing treatment apparatus. The clothing treatment apparatus is used to perform washing, rinsing, ironing, drying, and other processes on clothing. The clothing treatment apparatus includes, but is not limited to, a washing machine, a dryer, a washer-dryer combination unit, and other clothing treatment apparatuses. FIG. 1 illustrates a clothing treatment apparatus 1000, which includes a clothing accommodating device 1100 for accommodating clothing to be processed (which may be arranged to include an inner drum and an outer drum), a drying device 2000, and an air outlet duct 1300. The air outlet duct 1300 connects the clothing accommodating device 1100 and the drying device 2000. The air outlet duct 1300 is configured to guide airflow from the clothing accommodating device 1100 to the drying device 2000. The relative position between the clothing accommodating device 1100 and the drying device 2000 may be arranged either vertically or front-to-back, which is not limited by the present application.

In one embodiment of the present application, the humid airflow in the clothing accommodating device 1100 passes through the air outlet duct 1300 and enters the drying device 2000. After being dried by the drying device 2000, the humid airflow re-enters the clothing accommodating device 1100, thereby forming a circulating airflow between the clothing accommodating device 1100 and the drying device 2000.

In one embodiment of the present application, the drying device 2000 may include a moisture adsorption-desorption rotary disk and a driving part for driving the rotation of the moisture adsorption-desorption rotary disk. The moisture adsorption-desorption rotary disk is provided with a moisture adsorption agent for adsorbing water. The moisture adsorption agent may be zeolite, alkali metal aluminosilicate, lithium chloride, silica gel, modified silica gel, activated alumina, among others.

In one embodiment of the present application, the moisture adsorption-desorption rotary disk is divided by a sealing system into a moisture adsorption zone and a regeneration zone. Under the drive of the driving part, the moisture adsorption-desorption rotary disk rotates slowly. When the humid airflow from the clothing accommodating device 1100 passes through the moisture adsorption zone of the moisture adsorption-desorption rotary disk, some of the moisture is adsorbed by the moisture adsorption medium in the rotary disk. The dried air that has passed through the moisture-adsorbing process enters the clothing accommodating device 1100 to dry the clothing therein. Meanwhile, the rotary disk gradually approaches saturation as it adsorbs a certain amount of moisture. In the regeneration zone of the moisture adsorption-desorption rotary disk, another stream of air may first pass through a heater, then become high-temperature air, and pass through the saturated rotary disk after the moisture adsorption. This causes the water adsorbed by the rotary disk to evaporate, thereby restoring the dehumidification capacity of the rotary disk. Typically, the humid air from the clothing accommodating device 1100 carries some impurities, such as lint shed from the clothes. If these impurities, like lint, are not filtered, the humid air would bring these impurities into the drying device 2000, where the impurities adhere to the moisture adsorption-desorption rotary disk. This could result in clogging of the moisture adsorption-desorption rotary disk. Or, lint adhered to the moisture adsorption-desorption rotary disk could ignite when passing through the heater, causing damage to the moisture adsorption-desorption rotary disk.

Therefore, in one embodiment of the present application, a filter 601 may be arranged along the airflow path of the humid air in the clothing accommodating device 1100 to filter out impurities such as lint. For example, as shown in FIG. 2, the filter 601 may be arranged within the air outlet duct 1300 that connects the clothing accommodating device 1100 and the drying device 2000. For example, to increase the filtration area of the filter 601, the filter 601 may be obliquely arranged within the air outlet duct 1300. During the operational process of the clothing treatment apparatus, if the filter 601 is not cleaned for a long time, impurities such as lint adhering to the filter may clog the airflow within the air outlet duct 1300, thereby affecting the drying efficiency of the clothing treatment device.

To address the above issue, one embodiment of the present application provides a filter cleaning device for cleaning impurities adhered to the filter. The filter cleaning device may be a spraying device that removes impurities adhered to the filter with a cleaning solution sprayed by the spraying device.

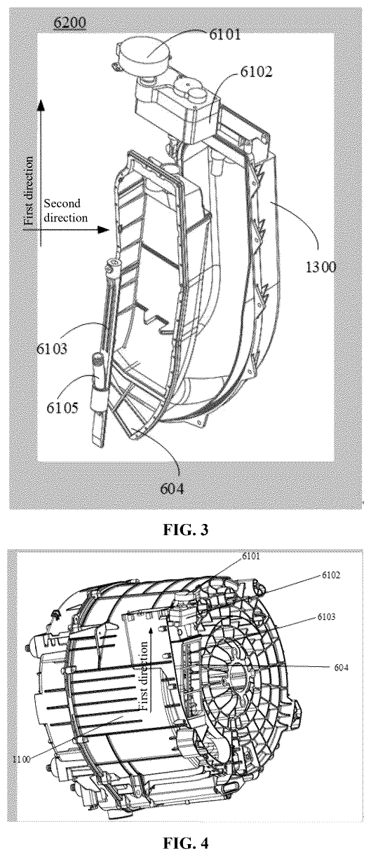

As shown in FIG. 3, in one embodiment of the present application, the filter cleaning device 6200 may include a driving mechanism and a spraying mechanism. The driving mechanism includes a drive motor 6101 and a transmission part (such as the gearbox 6102 shown in FIG. 3). The spraying mechanism includes a spray head 6103 and a water supply pipe 6105. The spray head 6103 may include one or more spray holes that are spaced apart from each other. For example, the structure of the spray head 6103 may be similar to that of a shower head. The spray holes may be arranged row by row from top to bottom or column by column from left to right. The spray holes may be arranged in one row or a plurality of rows, as well as in one column or a plurality of columns. The spray holes may be arranged regularly; for example, the spray holes may be spaced apart at equal intervals. Alternatively, the spray holes may be arranged irregularly or randomly distributed according to a certain pattern. As shown in FIG. 5, the shortest distance between two adjacent spray holes 6104 is denoted as d3. FIG. 3 illustrates a filter cleaning device 6200, which includes a drive motor 6101, a gearbox 6102, a spray head 6103, a water supply pipe 6105, and a filter support 604 (a filter 601 providing a filtration function is arranged within the filter support 604).

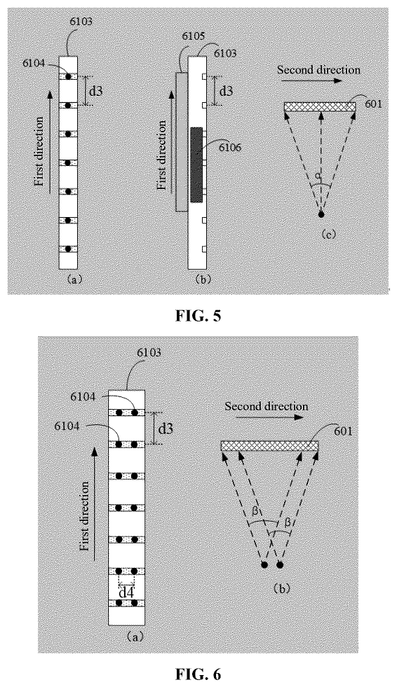

FIG. 4 illustrates a filter cleaning device 6200 for cleaning the filter 601, which is arranged on the outer wall of the clothing accommodating device 1100. The filter cleaning device includes at least the drive motor 6101, the gearbox 6102, the spray head 6103, and the filter support 604 as described above. Referring to FIG. 4, the drive motor 6101 and gearbox 6102 cooperate to enable the spraying mechanism to move along the first direction (the length direction of the spraying mechanism). This allows the cleaning fluid (the spraying fluid, which may be water or water with detergent added) to cover both the upper and lower ends of the filter 601 in the first direction. The spraying mechanism may rotate around a rotation axis, enabling the spraying fluid to cover both the left and right ends of the filter 601 in the second direction.

In one embodiment, the specific structure of the spray head 6103 is as shown in FIG. 5. FIG. 5(a) is a front view of the spray head 6103, which illustrates the front surface of the spray head 6103, i.e., the surface of the spray head 6103 that faces the filter 601 (directly confronting the filter 601). FIG. 5(b) is a side view of the spray head 6103. The movement distance of the spraying mechanism in the first direction is greater than or equal to the shortest distance d3 between two adjacent spray holes 6104, such that all positions of the filter 601 can be directly sprayed by the spraying fluid, avoiding any positions on the filter 601 being missed. This ensures that the filter cleaning device 6200 can comprehensively clean the entire filter 601.

In one embodiment, the spray head 6103 is rotatable, allowing the sprayed fluid to cover the filter 601 in the second direction. In this embodiment, the rotation of the spray head 6103 may be driven by the drive motor 6101 and the gearbox 6102. This enables the spray holes 6104 to rotate at a preset rate, thereby removing lint and impurities adhered to the filter 601.

The spraying mechanism can move along the length direction thereof to allow the spraying fluid to cover the filter 601 in the first direction. The length direction of the spraying mechanism is the first direction. The spraying mechanism rotates by a first angle with the first direction as its axis (the rotation axis of the spraying mechanism is parallel to the first direction) to expand the area of the filter 601 covered by the spraying fluid. In one embodiment, as shown in FIG. 5(c), the first angle α ranges from 5° to 45°. In FIG. 5(c), the direction facing the paper is the first direction. Specifically, the first angle α may be set to 5°, 12°, 16°, 19°, 24°, 28°, 31°, 37°, 42°, 45°, or other angles. The rotation angle of the first angle α may be selected based on the varying widths of the filter 601. In this embodiment, the movement of the spraying mechanism enables the spraying fluid to cover 80% or more of the region of the filter 601.

In one embodiment, the spraying mechanism further includes a switch for opening or closing one or more of the plurality of spray holes. The switch can control the opening or closing of the spray holes. The switch may be configured as an integrally formed structure or as a plurality of discrete structures. As shown in FIG. 5, the spraying mechanism includes a first blocking block 6106. The first blocking block 6106 is arranged on one side of the spray head 6103 distal to the water supply pipe 6105 and is used to block one or more of the plurality of spray holes 6104. The spray head 6103 is provided with a cavity, and the first blocking block 6106 is arranged within the cavity. The first blocking block 6106 can move up and down. The first blocking block 6106 can move up and down along the first direction. In the actual application of the clothing treatment apparatus, the relative position between the spraying mechanism and the filter 601 may be arranged as a first position, that is, the spraying mechanism and the filter 601 are spaced apart from each other in parallel in the first direction. The specific distance of the parallel spacing may be adjusted according to different air outlet ducts 1300. With continued reference to FIG. 5(b), the first blocking block 6106 can initially cover some of the lower spray holes 6104. On the one hand, this increases the water pressure of the upper spray holes 6104, achieving the maximum cleaning effect on the upper filter 601. On the other hand, during the cleaning process of the upper filter 601, some lint and impurities at the lower part of the filter 601 may also be carried away by the filtered water. Once the lint and impurities on the upper filter 601 are fully cleaned, the first blocking block 6106 slowly moves downward, exposing more spray holes 6104 to further wash away the lint and impurities in the middle and lower parts of the filter 601. Ultimately, the filter 601 can be cleaned using varying water pressures. Specifically, the number of spray holes 6104 that can spray fluid (spray volume), the speed of the spraying fluid in the spray holes 6104 (spray velocity), and the pressure of the spraying fluid in the spray holes 6104 (spray pressure) can be controlled by arranging a faucet/water valve.

In this embodiment, the spray volume, spray velocity, spray pressure, and spray angle of the spraying mechanism can all be adjusted, thereby enhancing the cleaning effect of the spraying mechanism on the filter 601.

In one embodiment, the filter 601 includes a filtering surface and a non-filtering surface that are opposite to each other. The filtering surface is the surface of the filter 601 that the airflow first contacts. The non-filtering surface is the surface through which airflow exits the filter screen 601. The spraying mechanism is arranged on the side of the non-filtering surface and is arranged to face the filter 601, enabling the removal of lint and impurities filtered by the filter screen 601 from the side of the non-filtering surface.

In one embodiment, the spraying mechanism is located on a first plane formed by the first direction and the second direction. The angle between the first plane and the plane of the filter 601 is less than 90°. For example, the first plane is parallel to the plane of the filter 601. In this case, the spraying mechanism does not make any contact with the filter 601. When the angle between the first plane and the plane of the filter 601 is greater than 0° but less than 90°, the end of the filter 601 close to the clothing accommodating device (i.e., the lower end of the spraying mechanism) can be arranged to make contact with the spraying mechanism.

In one embodiment, the distance between the spraying mechanism and the filter 601 is within the range of 0.4 cm to 1 cm. For example, the distance between the spraying mechanism and the filter 601 may be set to 0.4 cm, 0.54 cm, 0.65 cm, 0.84 cm, 0.93 cm, 1 cm, or other values. The distance between the spraying mechanism and the filter 601, according to this embodiment, is a rational design based on parameters such as the spraying range of the spraying mechanism and the spatial arrangement of the clothing treatment apparatus.

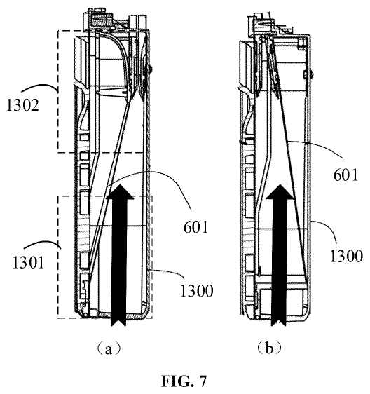

In one embodiment, as shown in FIG. 6, FIG. 6(a) illustrates the front surface of the spray head 6103, i.e., the surface of the spray head 6103 facing the filter 601. A plurality of rows/columns of spray holes 6104 can be arranged on the spray head 6103. The spray holes 6104 may be arranged row by row from top to bottom or column by column from left to right. In the first direction, the shortest distance between two adjacent spray holes 6104 is denoted as d3. In the second direction, the shortest distance between two adjacent spray holes 6104 is denoted as d4. The value ranges for d3 and d4 may be identical. In FIG. 6(b), the direction facing the paper surface is the first direction. The rotation angle of the spray holes 6104 around the rotation axis is the second angle β. Given the determined width of the filter 601, the range of the second angle β may be smaller than the first angle α; for example, the second angle β may be set between 3° to 40°.

In this embodiment, the spraying mechanism includes a plurality of spray holes 6104 for spraying water. The spray holes 6104 may be configured as spray holes 6104 arranged row by row from top to bottom or column by column from left to right. The displacement of the spraying mechanism in the first direction is greater than or equal to the minimum distance between two spray holes 6104. The swinging angle of the spraying mechanism around the rotation axis (the first angle α and/or the second angle β) enables the spraying fluid to reach the edges of the length and/or width of the filter 601. In one embodiment, the spraying fluid from the spraying mechanism reaches at least 80% of the area of the filter 601. In one embodiment, the spraying fluid from the spraying mechanism reaches at least 90% of the length of the filter 601. Alternatively, the spraying fluid from the spraying mechanism reaches at least 90% of the width of the filter 601.

In one embodiment, the clothing treatment apparatus further includes a drive motor 6101 and a gearbox 6102. The drive motor 6101 drives the gearbox 6102 to enable the movement of the spraying mechanism along the length direction thereof, and the drive motor 6101 drives the gearbox 6102 to enable the spraying mechanism to rotate along a direction perpendicular to the length direction thereof.

In one embodiment, FIG. 7 illustrates that the air outlet duct 1300 includes a first end 1301 close to the clothing accommodating device and a second end 1302 close to the drying device 2000. The filter 601 is arranged to span across the first end 1301 and the second end 1302 of the air outlet duct 1300, as shown in the two arrangement modes illustrated in FIG. 7(a) or 7(b).

In this embodiment, if the air outlet duct 1300 is a cylindrical structure, the filter 601 is an elliptical mesh structure with a second hole. The filter 601 spans across the first end 1301 and the second end 1302 of the air outlet duct 1300. Specifically, the filter 601 has a contact surface with the pipe wall of the first end 1301, and the filter 601 also has a contact surface with the pipe wall of the second end 1302. In this embodiment, the arrangement mode of the filter 601 allows the airflow within the air outlet duct 1300 to undergo thorough filtration.

In one embodiment, the spraying mechanism is arranged to span across the first end 1301 and the second end 1302 of the air outlet duct 1300, thus facilitating more convenient spray-cleaning of the filter 601.

In a group of embodiments of the present application, a method for controlling a clothing treatment apparatus is provided. The clothing treatment apparatus may be the clothing treatment apparatus 1000 shown in FIG. 1. The clothing treatment apparatus includes the filter cleaning device described above, and further includes a water supply assembly. The water supply assembly includes at least a filter water supply port; the filter water supply port is connected to the spraying mechanism. The filter cleaning device further includes a control module.

The method for controlling a clothing treatment apparatus includes at least:
controlling, by the control module, the supply of water from the filter water supply port to the spraying mechanism;
controlling, by the control module, the driving mechanism to move the spraying mechanism reciprocally along the first direction; and
controlling, by the control module, the driving mechanism to rotate the spraying mechanism reciprocally around the rotation axis of the spraying mechanism, to spray the cleaning fluid onto the filter.

In this embodiment, the filter cleaning device can move reciprocally along the first direction alone, rotate reciprocally around the rotation axis of the spraying mechanism alone, or simultaneously move reciprocally along the first direction and rotate reciprocally around the rotation axis of the spraying mechanism to spray the filter, thereby removing clothing debris, paper scraps, cotton fibers, lint, or other impurities generated in the clothing treatment apparatus. The control module can also adjust the spray volume, spray velocity, spray pressure, and spray angle of the spraying mechanism to enhance the cleaning effect of the spraying mechanism on the filter 601.

In a group of embodiments of the present application, a clothing treatment apparatus is provided, which includes: a clothing accommodating device 1100 and a drying device 2000. The drying device 2000 includes: a housing, a moisture adsorption-desorption rotary disk, a driving part of the moisture adsorption-desorption rotary disk, a circulation fan, a regeneration fan, a regeneration heating module, a condensation module, a filter cleaning device, a memory, and a processor.

The circulation fan, the regeneration fan, the moisture adsorption-desorption rotary disk, the regeneration heating module, the condenser, the filter cleaning device, the memory, and the processor are communicatively connected to each other. The memory stores computer instructions, and the processor executes the computer instructions to implement the method for controlling a clothing treatment apparatus described in any one of the above embodiments.

In a group of embodiments of the present application, a computer-readable storage medium is provided. The storage medium stores an application program that, when run by a processor, causes the processor to implement the method for controlling a clothing treatment apparatus described in any one of the above embodiments.

In any one of the groups of embodiments/any one of the embodiments described above in the present application, one or more features involved may be combined with each other to improve the drying efficiency of the drying device.

The above are only preferred embodiments of the present application, and are not intended to limit the present application. For those skilled in the art, the present application can be modified and varied. Any modification, equivalent replacement, improvement, and the like made within the spirit and principle of the present application shall all fall within the protection scope of the present application. It should be noted that similar reference numerals and letters refer to similar items in the following drawings, and thus, once an item is defined in one figure, it need not be further defined or explained in the subsequent drawings.

The above descriptions are only embodiments of the present application, but the protection scope of the present application is not limited thereto. Any variations or substitutions that can be easily conceived by those skilled in the art within the technical scope disclosed in the present application shall be covered by the protection scope of the present application. Therefore, the protection scope of the present application shall be subject to the protection scope of the claims described.

1. A filter cleaning device for cleaning a filter in a clothing treatment apparatus, the filter cleaning device comprising: a driving mechanism and a spraying mechanism, wherein
the driving mechanism is configured to provide a driving force for movement of the spraying mechanism; and
the spraying mechanism is configured to spray a cleaning fluid onto a preset region of the filter.

2. The filter cleaning device according to claim 1, wherein the driving mechanism is configured to drive the spraying mechanism to move in a plurality of directions.

3. The filter cleaning device according to claim 2, wherein the driving mechanism is configured to drive the spraying mechanism to move in a first direction or a second direction, wherein the first direction and the second direction are perpendicular to each other.

4. The filter cleaning device according to claim 2, wherein the driving mechanism is configured to drive the spraying mechanism to rotate around a rotation axis.

5. The filter cleaning device according to claim 3, wherein an area of the preset region is greater than or equal to 80% of a filtration area of the filter.

6. The filter cleaning device according to claim 5, wherein the spraying mechanism comprises a water supply pipe and a spray head, the spray head being provided with a plurality of spray holes that are spaced apart from each other.

7. The filter cleaning device according to claim 6, wherein the water supply pipe and the plurality of spray holes are arranged on two surfaces of the spray head that face away from each other.

8. The filter cleaning device according to claim 7, wherein the spraying mechanism is configured such that a movement distance in an arrangement direction of the plurality of spray holes is greater than or equal to a minimum distance between two adjacent spray holes.

9. The filter cleaning device according to claim 7, wherein a rotation angle of the spraying mechanism ranges from 5° to 45°.

10. The filter cleaning device according to claim 6, wherein the spraying mechanism further comprises a switch for opening or closing one or more of the plurality of spray holes.

11. The filter cleaning device according to claim 1, wherein the filter comprises a filtering surface and a non-filtering surface, and the spraying mechanism is arranged on a side of the non-filtering surface.

12. The filter cleaning device according to claim 1, wherein a distance between the spraying mechanism and the filter is within a range of 0.4 cm to 1 cm.

13. A clothing treatment apparatus, comprising a clothing accommodating device, a drying device, a water supply assembly, and an air outlet duct connecting the clothing accommodating device and the drying device, wherein the air outlet duct is configured to guide an airflow from the clothing accommodating device to the drying device;
a filter is arranged in the air outlet duct to filter the airflow;
the clothing treatment apparatus further comprises the filter cleaning device according to claim 1; and
the water supply assembly comprises a filter water supply port; the filter water supply port is connected to the spraying mechanism.

14. The clothing treatment apparatus according to claim 13, wherein the air outlet duct comprises a first end close to the clothing accommodating device and a second end close to the drying device, and the filter cleaning device is arranged in the air outlet duct in a manner spanning across the first end and the second end.

15. A method for controlling a clothing treatment apparatus, wherein the clothing treatment apparatus comprises a clothing accommodating device, a drying device, a water supply assembly, and an air outlet duct connecting the clothing accommodating device and the drying device, wherein the air outlet duct is configured to guide an airflow from the clothing accommodating device to the drying device;
a filter is arranged in the air outlet duct to filter the airflow;
the clothing treatment apparatus further comprises the filter cleaning device according to claim 1, configured to spray liquid onto the filter;
the water supply assembly comprises at least a filter water supply port; the filter water supply port is connected to the spraying mechanism; and
the filter cleaning device further comprises a control module; and wherein
the method for controlling the clothing treatment apparatus comprises at least:
controlling, by the control module, a supply of water from the filter water supply port to the spraying mechanism;
controlling, by the control module, the driving mechanism to move the spraying mechanism reciprocally along a first direction; and
controlling, by the control module, the driving mechanism to rotate the spraying mechanism reciprocally around a rotation axis of the spraying mechanism, to spray a cleaning fluid onto the filter.

16. The filter cleaning device according to claim 7, wherein the spraying mechanism is movable along a length direction of the spraying mechanism to allow a spraying fluid to cover the filter in a first direction; and the length direction of the spraying mechanism is the first direction.

17. The filter cleaning device according to claim 10, wherein the spraying mechanism comprises a first blocking block; the first blocking block is arranged on one side of the spray head distal to the water supply pipe and is used to block one or more of the plurality of spray holes.

18. The filter cleaning device according to claim 17, wherein the spray head is provided with a cavity, and the first blocking block is arranged within the cavity; the first blocking block is able to move up and down along the first direction.

19. The filter cleaning device according to claim 3, wherein the spraying mechanism is located on a first plane formed by the first direction and the second direction; and an angle between the first plane and a plane of the filter is less than 90°.

20. The filter cleaning device according to claim 1, wherein a spraying fluid from the spraying mechanism reaches at least 90% of a length of the filter; or
a spraying fluid from the spraying mechanism reaches at least 90% of a width of the filter.
